(19) United States
(12) Patent Application Publication
(10) Pub. No.: US 2025/0303478 A1
(43) Pub. Date: Oct. 2, 2025

(54) DRILL BIT

(71) Applicant: Bradley Joseph Goschke, Hale, MI (US)

(72) Inventor: Bradley Joseph Goschke, Hale, MI (US)

(21) Appl. No.: 18/617,378

(22) Filed: Mar. 26, 2024

(51) Int. Cl. B23B 51/00

(52) U.S. Cl. CPC B23B 51/00

(57) ABSTRACT

A drill bit includes a cylindrical rod that has a tip or point formed by pinch cutting the rod such that the rod has a work-hardened fracture surface. The drill bit may be stainless steel and have sufficient flexural modulus and flexural yield strength to enable significant bending of the drill bit to enable the transmission of torque at an angle during drilling.

### TECHNICAL FIELD

This disclosure relates to drill bits.

### BACKGROUND OF THE INVENTION

Drill bits are cutting tools for forming holes in a workpiece. Drill bits include a tip or point that engages with the workpiece. Drill bits also typically include flutes, i.e., deep spiral grooves along at least a portion of the length of the drill bit, that transport material from the tip as the hole is being formed. Drill bits are typically connected to a drill, which rotates the drill bit. The rotation of the drill bit with the tip in contact with the workpiece removes material from the workpiece, thereby forming a hole.

### SUMMARY

According to a first aspect of the disclosure, a drill bit includes a cylindrical rod having a first end and a second end. The first end defines a tip formed by pinch cutting the cylindrical rod on a plane that forms an angle with the rod's axis that is between ninety and 180 degrees.

The drill bit according to the first aspect of the disclosure improves upon the prior art by providing a drill bit that is economical to manufacture because it involves a single operation to produce the tip or point. The use of pinch cutting, as opposed to shear cutting, results in work hardening of the tip, which enables the use of softer, more flexible material.

Pinch cutting may also result in the formation of material folds or heads at the tip, which will assist in cutting and removing material from the workpiece during hole formation. The drill bit according to the first aspect of the disclosure is characterized by the absence of flutes, i.e., the drill bit is a circular cylinder along its entire length except for the pinch-cut tip. With the drill bit being a circular cylinder with the exception of the pinch-cut tip, the drill bit provided herein reduces or eliminates the possibility that carpet, insulation, or other fibrous substances that may be near the workpiece will be damaged by being wound around the spinning drill bit.

In one embodiment, the drill bit comprises a stainless steel alloy having sufficient ductility and elasticity that the drill bit can be bent, either elastically or plastically, so that the first end is approximately forty-five degrees from the second end, thereby enabling access to workpieces that would otherwise be inaccessible due to the length of a straight drill bit and drill.

According to a second aspect of the invention, a method of forming a drill bit includes possessing a circular cylindrical rod having a first end and a second end. The method also includes pinch cutting the rod. Pinch cutting the rod may include positioning the rod between first and second blades such that the first and second blades are coplanar within a plane that intersects the rod, and moving the first and second blades toward one another within the plane to cause pinch compression on the rod until the rod fractures.

According to a third aspect of the invention, a method of using a drill bit includes possessing a drill bit that is a cylindrical rod having a first end and a second end. The first end defines a tip formed by pinch cutting the cylindrical rod. The method also includes placing the tip against a workpiece, and rotating the drill bit.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, side view of a drill bit in accordance with the claimed invention;

FIG. 2 is a schematic, top view of one end of the drill bit of FIG. 1;

FIG. 3 is a schematic, perspective view of the end of the drill bit of FIG. 2;

FIG. 4 is a schematic, side view of a rod used to form the drill bit of FIGS. 1-3;

FIG. 5 is a schematic, perspective view of the rod of FIG. 4;

FIG. 6 is schematic, cross-sectional view of the rod of FIG. 4 between two blades in an initial position taken about a plane that intersects the rod at an angle that is between ten and eighty degrees; and

FIG. 7 is a schematic, cross-sectional view of the two blades in a final position taken about the plane; and

FIG. 8 is a schematic, side view of the drill bit of FIG. 1 operatively connected to a drill and engaging a workpiece.

### DETAILED DESCRIPTION

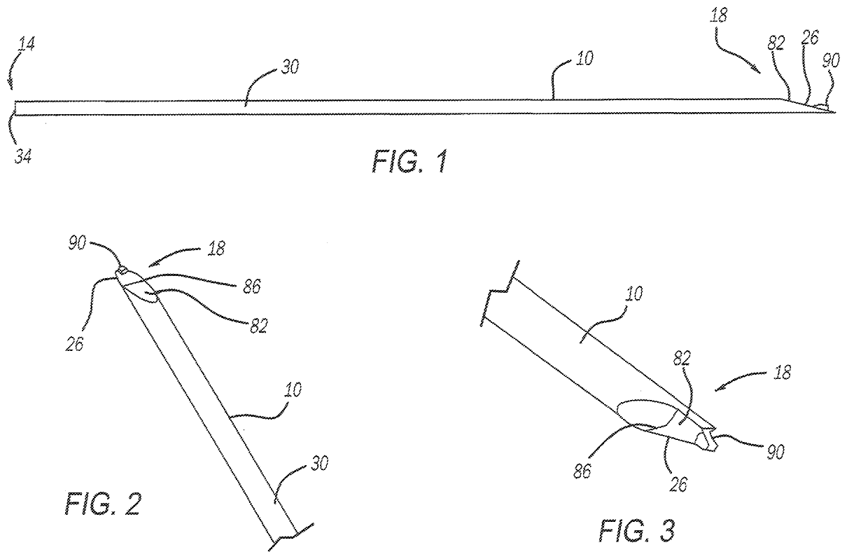

Referring to FIGS. 1-3, wherein like reference numbers refer to like components, a drill bit 10 is schematically depicted. The drill bit 10 has a first end 14 and a second end 18. The first end 14 is engageable with a drill (such as the one shown at 22 in FIG. 8), and the second end 18 defines a tip or point 26 that is configured to engage a workpiece for forming a hole therein. The drill bit 10 is a circular cylinder except for the tip 26 at end 18.

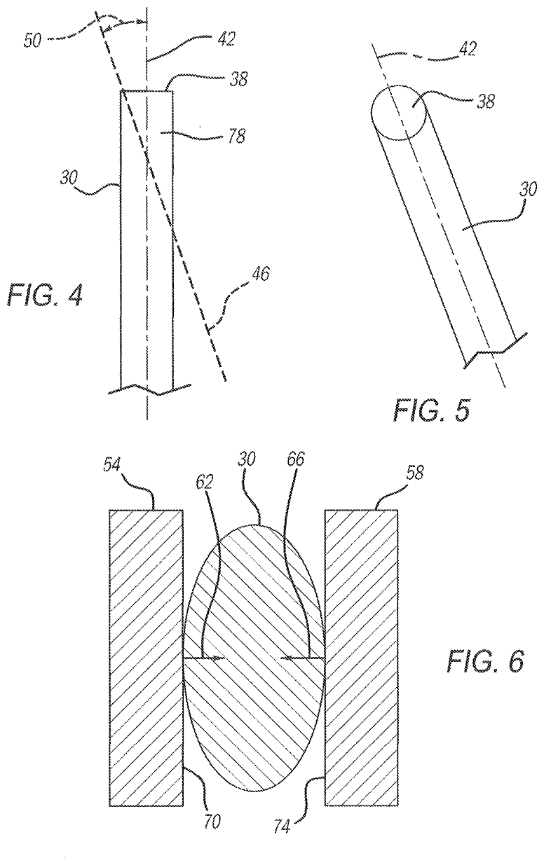

The drill bit 10 is a cylindrical rod 30 that has been processed to form the tip 26. A method of forming the tip 26 is schematically depicted in FIGS. 4-6. Referring to FIGS. 4-7, wherein like reference numbers refer to like components from FIGS. 1-3, the method includes possessing a cylindrical rod 30. The rod 30 is depicted in FIGS. 4-6 prior to the formation of tip 26. The cylindrical rod 30 is a right circular cylinder having two parallel circular bases, one of which is at end 14 (shown at 34 in FIG. 1) and the other circular base is shown at 38 in FIGS. 4 and 5. The rod 30 has a centerline or axis 42.

A plane 46 intersects the cylindrical rod 30 at or near circular base 38 as shown in FIG. 4. The plane 46 intersects the rod 30 such that the plane 46 forms an angle 50 with the centerline 42. Angle 50 is preferably between 10 degrees and 80 degrees, and more preferably between 30 degrees and 60 degrees. FIG. 6 is a cross-sectional view of the rod 30 at the plane 46. As shown in FIG. 6, the intersection of the plane 46 and the rod 30 is an ellipse.

Referring specifically to FIG. 6, the method further includes positioning a first blade 54 and a second blade 58 such that the blades 54, 58 are coplanar within plane 46 and the rod 30 is between the blades 54, 58. The blades 54, 58 are movable relative to one another within plane 54, 58. Preferably, the motion of the blades 54, 58 is limited such that relative movement between the blades 54, 58 is limited to motion within the plane 46. As the blades 54, 58 move relative to one another, the velocity vectors 62, 66 of the blades 54, 58 are within plane 46. In other words, all points in the velocity vectors 62, 66 of blades 54, 58 are in the plane 46.

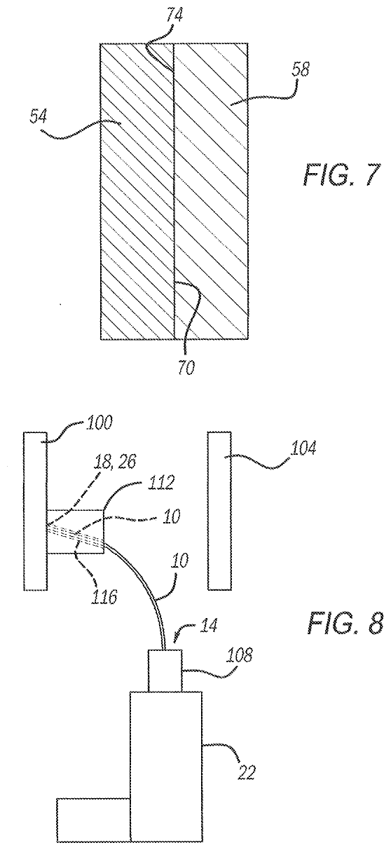

The method includes causing the blades 54, 58 to move toward each other such that the velocity vectors 62, 66 of blades 54, 58 lie within plane 46 such that the blades 54, 58 exert a pinch compressive force on the rod 30. The compressive force of the blades 54, 58 causes plastic strain in the rod 30. Movement of the blades 54, 58 towards each other continues at least until fracture of the rod 30 occurs. In one embodiment, the blades 54, 58 move to the positions shown FIG. 7, in which the blades 54, 58 contact one another and, more specifically, the edges 70, 74 of the blades 54, 58 contact each other.

When the fracture occurs, a portion 78 of the rod 30 separates from the remainder of the rod 30. Portion 78 includes most or all of the circular base 38. With portion 78 removed, tip 26 is formed in the remainder of the rod 30, and includes the fracture surface 82 from which portion 78 broke away. Fracture surface 82 approximates plane 46.

It should be noted that the pinch compression that occurs between blades 54, 58 in the method provided herein is distinguished from a shear cut, in which blades slide past each other in parallel planes to generate a net shear of a workpiece. In contrast, the pinch compression caused by blades 54, 58 does not involve a net shear of the rod 30. The pinch compression results in work hardening of the tip 26 at surface 82, and may result in various geometric features such as a ridge 86 and a pinch head 90 that protrudes from the fracture surface 82.

The movement of the blades 54, 58 within the plane 46 may be linear, or rotation of the blades 54, 58 about axes perpendicular to the plane 46 may also occur within the scope of the claimed invention. Those skilled in the art will recognize a variety of devices for effectuating the planar movement of the blades 54, 58 including but not limited to pinch pliers, bolt cutters, etc.

In the embodiment depicted, the rod 30 is a stainless steel alloy, and, more specifically, is UNS (Unified Numbering System) S30200, commonly known as “302 Stainless Steel.” The composition of the rod 30 is 0.00-0.15% carbon, 18-20% chromium, 0-2% manganese, 8-10% nickel, 0.000-0.045% phosphorous, 0-1% silicon, and 0.00-0.030% sulfur.

The composition of the rod 30, and, correspondingly, the drill bit 10, enables the drill bit 10 to bend significantly within the elastic deformation range, i.e., prior to plastic deformation. More specifically, the drill bit 10 is elastically bendable, as shown in FIG. 8, such that the drill bit 10 adjacent to the first end 14 forms at least a forty-five degree angle with the second end 18, and, more preferably, forms at least a seventy-five degree angle. The bending or flexural modulus will depend on the diameter to the rod 30. In the embodiment depicted, the diameter of the rod 30 is less than or equal to 3/32 inches.

Referring specifically to FIG. 8, wherein like reference numbers refer to like components from FIGS. 1-7, a method of using the drill bit 10 is schematically depicted. The method includes placing the tip 26 or end 18 in contact with a workpiece 100. In the embodiment depicted, the workpiece 100 is a wooden member of a frame structure, such as in a house, and is adjacent to another wooden member 104. For example, the workpiece 100 and member 104 could be wall studs, floor joists, etc. It should be noted that workpiece 100 could be any material or member in which a hole is desired.

The method further includes rotating the drill bit 10 with the tip 26 engaged with the workpiece 100, which will cause the tip to form a hole in the workpiece 100. Preferably, the rotation of the drill bit 10 is achieved by the power drill 22. More specifically, the end 14 of the drill bit 10 is connected to the chuck 108 of the drill 22 for rotation therewith. The chuck 108 is connected to an electric motor to receive torque therefrom, as understood by those skilled in the art.

The method may include bending the drill bit 10 prior to rotating the drill bit as shown in FIG. 8. The drill bit 10 improves upon the prior art by facilitating the formation of holes in areas where a drill and drill bit would not fit. As shown in FIG. 8, if the drill bit 10 were linear, member 104 would prevent the use of the drill bit 10 and drill 22 because of physical part interference. Bending the drill bit 10 enables the drill 22 to be placed outside the space formed between the workpiece 100 and member 104, thereby enabling the formation of a hole in workpiece 100. Bending the drill bit 10 may include bending the drill bit 10 so that the portion of the drill bit 10 adjacent end 14 forms an angle with the portion adjacent end 18 that is between forty-five and ninety degrees.

A guide member 112 may be employed to assist in retaining the drill bit 10 in the desired position and bend angle. The guide member 112 is a piece of material defining a hole 116 extending therethrough. The method may include inserting the drill bit through the hole 116 prior to engaging the tip 26 with the workpiece. The guide member 112 may be placed in abutment with the workpiece. The guide member 112 enables a user to indirectly hold the drill bit and prevents or limits unwanted bending or flexing.

While the best modes for carrying out the disclosure have been described in detail, those familiar with the art to which this disclosure relates will recognize various alternative designs and embodiments for practicing the disclosure within the scope of the appended claims.

1. A drill bit comprising:
a cylindrical rod having a first end and a second end;
wherein the second end defines a tip formed by pinch cutting the cylindrical rod through the rod's axis.

2. The drill bit of claim 1, wherein the rod is a stainless steel alloy.

3. The drill bit of claim 2, wherein the rod is comprised of 0.00-0.15% carbon, 18-20% chromium, 0-2% manganese, 8-10% nickel, 0.000-0.045% phosphorous, 0-1% silicon, and 0.00-0.030% sulfur.

4. The drill bit of claim 2, wherein the rod has a diameter not greater than 3/32 of an inch.

5. The drill bit of claim 1, wherein the tip includes a pinch head comprised of material that is work-hardened by the pinch cutting.

6. The drill bit of claim 1, wherein the tip includes a fracture surface; and
wherein the rod is cylindrical except the fracture surface.

7. A method of manufacturing a drill bit comprising:
possessing a cylindrical rod having a first end and a second end;
causing the rod to be between first and second blades such that the first and second blades are coplanar within a plane that intersects the rod; and
moving the first and second blades toward one another within the plane to cause pinch compression on the rod until the rod fractures.

8. The method of claim 7, wherein the intersection of the plane and the rod is an ellipse.

9. The method of claim 8, wherein the plane forms and angle with the centerline of the rod that is between ten degrees and eighty degrees.

10. The method of claim 8, wherein the rod is stainless steel.

11. The method of claim 10, wherein the rod is comprised of 0.00-0.15% carbon, 18-20% chromium, 0-2% manganese, 8-10% nickel, 0.000-0.045% phosphorous, 0-1% silicon, and 0.00-0.030% sulfur.

12. The method of claim 10, wherein the diameter of the rod is not greater than 3/32 inches.

13. A method comprising:
possessing a drill bit that is a cylindrical rod having a first end and a second end, said second end defining a tip formed by pinch cutting the cylindrical rod;
placing the tip against a workpiece; and
rotating the drill bit.

14. The method of claim 13, further comprising bending the drill bit such that the portion of the drill bit adjacent to the first end is at least forty-five degrees from the portion of the drill bit adjacent to the second end.

15. The method of claim 13, further comprising possessing a drill bit guide defining a hole; and
prior to said rotating the drill bit, extending the drill bit through the hole.
